(19) United States
(12) Patent Application Publication
(10) Pub. No.: US 2025/0103267 A1
(43) Pub. Date: Mar. 27, 2025

(54) ELECTRIC DEVICE AND OPERATION METHOD THEREOF

(71) Applicant: Samsung Electronics Co., Ltd., Suwon-si (KR)

(72) Inventors: Kilsoo CHOI, Suwon-si (KR); Sehyun KIM, Suwon-si (KR); Jongin LEE, Suwon-si (KR); Hyeeun PARK, Suwon-si (KR)

(73) Assignee: Samsung Electronics Co., Ltd., Suwon-si (KR)

(21) Appl. No.: 18/973,947

(22) Filed: Dec. 9, 2024

Related U.S. Application Data
(63) Continuation of application No. PCT/KR2023/007029, filed on May 23, 2023.

(30) Foreign Application Priority Data
Jun. 9, 2022 (KR) 10-2022-0070378

(51) Int. Cl. G06F 3/14; G06T 3/60

(52) U.S. Cl. CPC G06F 3/14; G06T 3/60

(57) ABSTRACT

An electronic device and an operation method thereof. The electronic device includes a memory and a processor configured to identify a usage environment of the electronic device based on receiving a request associated with displaying an image through a display of the electronic device, select one of a first mode or a second mode based on which the image is to be displayed, according to the identified usage environment of the electronic device. The processor is configured to, based on the first mode being selected, change Extended Display Identification Data (EDID), transmit the changed EDID to a source device from which the image is received, receive an adjusted image according to the changed EDID from the source device, and display the adjusted image on the display, and based on the second mode being selected, rotate the image received from the source device and display the rotated image on the display.

### CROSS-REFERENCE TO RELATED APPLICATION(S)

This application is a continuation application, claiming priority under § 111 (a), of International Application No. PCT/KR2023/007029, filed on May 23, 2023, which is based on and claims the benefit of Korean patent application number 10-2022-0070378, filed on Jun. 9, 2022, in the Korean Intellectual Property Office, the disclosures of which are incorporated by reference herein in their entireties.

### TECHNICAL FIELD

Various embodiments relate to an electronic device and an operation method thereof, and more particularly, to an electronic device and an operation method thereof for suitably processing and providing an image according to display rotation.

### BACKGROUND ART

An electronic device with a display, such as a television (TV), receives a broadcast signal of a certain channel and displays an image based on the received broadcast signal. In addition to a broadcast signal, the electronic device may receive various pieces of media content from a server connected through a network such as the Internet and display an image based on the received pieces of media content on the display.

The display may display an image of content by operating in any one of a plurality of screen modes corresponding to different aspect ratios, for example, a horizontal mode (landscape mode) and a vertical mode (portrait mode).

When there is a display rotation request for switching the screen mode of the display of the electronic device from the horizontal mode to the vertical mode or from the vertical mode to the horizontal mode, the electronic device may need to suitably process an image displayed in the screen mode changed according to the display rotation.

### DISCLOSURE

### Technical Problem

Various embodiments provide an electronic device and an operation method of the electronic device that may adaptively control a screen rotation operation according to a usage environment of the electronic device.

### Technical Solution

According to an embodiment, an electronic device may include memory to store one or more instructions and at least one processor, individually and/or collectively, configured to execute the one or more instructions stored in the memory. According to an embodiment, the at least one processor, individually and/or collectively, is configured to execute the one or more instructions stored in the memory to cause the electronic device to identify a usage environment of the electronic device based on receiving a request associated with displaying an image through a display of the electronic device. According to an embodiment, the at least one processor, individually and/or collectively, is configured to execute the one or more instructions stored in the memory to cause the electronic device to select one of a first mode or a second mode based on which the image is to be displayed, according to the identified usage environment of the electronic device. According to an embodiment, the at least one processor, individually and/or collectively, is configured to execute the one or more instructions stored in the memory to cause the electronic device to, based on the first mode being selected, change Extended Display Identification Data (EDID), transmit the changed EDID to a source device from which the image is received, receive an image adjusted according to the changed EDID from the source device, and display the adjusted image on the display. According to an embodiment, the at least one processor, individually and/or collectively, is configured to execute the one or more instructions stored in the memory to cause the electronic device to, based on the second mode being selected, rotate the image received from the source device and display the rotated image on the display.

According to an embodiment, the at least one processor, individually and/or collectively, is configured to execute the one or more instructions stored in the memory to cause the electronic device to obtain at least one of information about a type of the source device, which is connected to the electronic device, user setting information according to a user input, or information about a type of content displayed on the electronic device so as to identify the usage environment of the electronic device.

According to an embodiment, the information about the type of the source device, the user setting information, and the information about the type of the content may be set with defined priorities, and the at least one processor, individually and/or collectively, is configured to execute the one or more instructions stored in the memory to cause the electronic device to select one of the first mode or the second mode as the display rotation mode by considering the usage environment of the electronic device from the information with a highest priority.

According to an embodiment, the usage environment of the electronic device may include a type of the source device connected to the electronic device, and the at least one processor, individually and/or collectively, is configured to execute the one or more instructions stored in the memory to cause the electronic device to identify the type of the source device which is connected to the electronic device based on receiving the request and select the first mode based on the identified type of the source device being identified as an EDID-changeable device and select the second mode based on the identified type of the source device being identified as an EDID-unchangeable device.

According to an embodiment, the usage environment of the electronic device may include a type of content displayed on the electronic device, and the at least one processor, individually and/or collectively, is configured to execute the one or more instructions stored in the memory to cause the electronic device to identify the type of the content displayed on the electronic device based on receiving the request and select the first mode based on the identified type of the content being identified as content sensitive to an input lag and select the second mode based on the identified type of the content being identified as content not sensitive to an input lag.

According to an embodiment, the usage environment of the electronic device may include user setting information according to a user input, and the at least one processor, individually and/or collectively, is configured to execute the one or more instructions stored in the memory to cause the electronic device to identify the user setting information based on receiving the request and select one of the first mode or the second mode according to the identified user setting information.

According to an embodiment, the at least one processor, individually and/or collectively, is configured to execute the one or more instructions stored in the memory to cause the electronic device to, based on selecting the first mode, change EDID of the electronic device from first EDID to second EDID, provide the second EDID to the source device and receive an image adjusted according to the second EDID from the source device, and control the adjusted image to be displayed on the display rotated according to the request.

According to an embodiment, the at least one processor, individually and/or collectively, is configured to execute the one or more instructions stored in the memory to cause the electronic device to detect that an error has occurred in a screen display of the adjusted image displayed on the rotated display, change the display rotation mode from the first mode to the second mode according to detection of the error, and perform a display rotation control operation according to the second mode.

According to an embodiment, the at least one processor, individually and/or collectively, is configured to execute the one or more instructions stored in the memory to cause the electronic device to detect that an error has occurred in a screen display of the adjusted image displayed on the rotated display and perform control to display a notification message to a user according to detection of the error.

According to an embodiment, an operation method of an electronic device includes identifying a usage environment of the electronic device based on receiving a request associated with displaying an image through a display of the electronic device, selecting one of a first mode or a second mode based on which the image is to be displayed, according to the identified usage environment of the electronic device, based on the first mode being selected, changing Extended Display Identification Data (EDID), transmitting the changed EDID to a source device, receiving an image adjusted according to the changed EDID from the source device, and displaying the adjusted image on a display, and based on the second mode being selected, rotating an image received from the source device and displaying the rotated image on the display.

According to an embodiment, a non-transitory computer-readable recording medium has recorded therein one or more program executed by a processor of an electronic device for implementation of an operation method of the electronic device, the operation method including identifying a usage environment of the electronic device based on receiving a request associated with displaying an image through a display of the electronic device, selecting one of a first mode or a second mode based on which the image is to be displayed, according to the identified usage environment of the electronic device, based on the first mode being selected, changing Extended Display Identification Data (EDID), transmitting the changed EDID to a source device, receiving an image adjusted according to the changed EDID from the source device, and displaying the adjusted image on a display, and based on the second mode being selected, rotating an image received from the source device and displaying the rotated image on the display.

### Advantageous Effects

According to various embodiments of the present disclosure, when an electronic device receives a display rotation command and performs an operation accordingly, a display rotation control operation may be performed by adaptively selecting Extended Display Identification Data (EDID) change or System-On-Chip (SOC) rotation, depending on a usage environment of the electronic device.

### DESCRIPTION OF DRAWINGS

FIG. 1 illustrates an example of a system for describing a display rotation control operation according to a display rotation command in an electronic device, according to described embodiments.

FIG. 2 is a schematic block diagram of an electronic device according to an embodiment.

FIG. 3 is a detailed block diagram of an electronic device according to an embodiment.

FIG. 4 illustrates an example of an operation method of an electronic device operating according to a display rotation command, according to an embodiment.

FIG. 5 is a flowchart of a method by which an electronic device performs a display rotation control operation according to an Extended Display Identification Data (EDID) change mode, according to an embodiment.

FIG. 6 is a reference diagram for describing an electronic device performing a display rotation control operation according to an EDID change mode, according to an embodiment.

FIG. 7 is a reference diagram for describing an operation of rotating and displaying an image in a System-On-Chip (SOC) rotation mode, according to an embodiment.

FIG. 8 illustrates an example of an operation method of an electronic device operating according to a display rotation command, according to an embodiment.

FIG. 9 illustrates an example of an operation method of an electronic device operating according to a display rotation command, according to an embodiment.

FIG. 10 illustrates an example of an operation method of an electronic device operating according to a display rotation command, according to an embodiment.

FIG. 11 illustrates an example of a flowchart of a method by which an electronic device performs a display rotation control operation based on one or more of information items obtained as a usage environment, according to an embodiment.

FIG. 12 is a flowchart of an example of a method of performing a display rotation control operation by changing EDID according to a display rotation command, according to an embodiment.

FIG. 13 is a flowchart of an example of a method of performing a display rotation control operation by changing EDID according to a display rotation command, according to an embodiment.

FIG. 14 illustrates an example of a method of performing a display rotation control operation by changing EDID according to a display rotation command, according to an embodiment.

FIG. 15 illustrates an example of a method of performing a display rotation control operation by changing EDID according to a display rotation command, according to an embodiment.

### MODE FOR INVENTION

Terms used herein will be briefly described and then the present disclosure will be described in detail.

The terms used herein are those general terms currently widely used in the art in consideration of functions in the present disclosure, but the terms may vary according to the intentions of those of ordinary skill in the art, precedents, or new technology in the art. Also, in some cases, there may be terms that are optionally selected by the applicant, and the meanings thereof will be described in detail in the corresponding portions of the present disclosure. Thus, the terms used herein should be understood not as simple names but based on the meanings of the terms and the overall description of the present disclosure.

Throughout the present disclosure, when something is referred to as “including” an element, one or more other elements may be further included unless otherwise specified. Also, as used herein, the terms such as “units” and “modules” may refer to units that perform at least one function or operation, and the units may be implemented as hardware or software or a combination of hardware and software.

Hereinafter, embodiments will be described in detail with reference to the accompanying drawings so that those of ordinary skill in the art may easily implement the embodiment. However, the present disclosure may be embodied in many different forms and should not be construed as being limited to the embodiments set forth herein. Also, portions irrelevant to the description of the present disclosure will be omitted in the drawings for a clear description of the present disclosure, and like reference numerals will denote like elements throughout the specification.

As used herein, the term “user” may refer to a person controlling the function or operation of a computing device or an electronic device by using a control device and may include a viewer, a manager, or an installer.

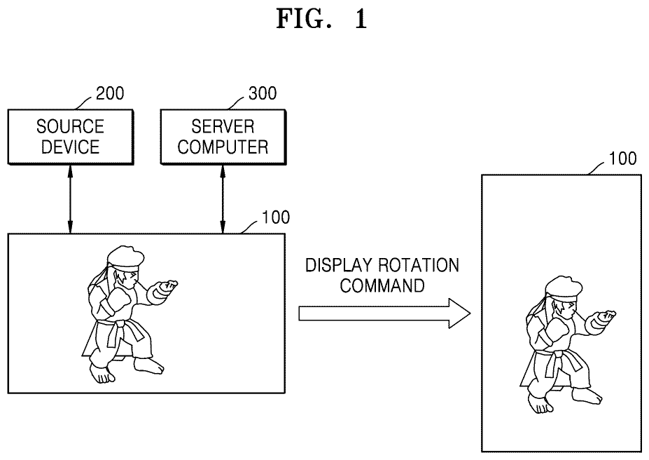

FIG. 1 illustrates an example of a system for describing a display rotation control operation according to a display rotation command in an electronic device, according to described embodiments.

Referring to FIG. 1, the system may include a source device 200, a server computer 300, and an electronic device 100.

The source device 200 may provide content such as video or audio to the electronic device 100. The source device 200 may include, for example, various types of electronic devices, such as a set-top box, a digital versatile disk (DVD) player, a Blu-ray disc player, a personal computer (PC), and a game console, that may provide content to the electronic device 100. The source device 200 may be referred to as a source device in terms of providing content and may also be referred to as a host device, a content providing device, an electronic device, a computing device, or the like.

The server computer 300 may provide content to the electronic device 100 through a communication network.

The electronic device 100 may output or display content received from the source device 200 or the server computer 300. The electronic device 100 may include, for example, various types of electronic devices, such as a network television (TV), a smart TV, an Internet TV, a Web TV, an IPTV, and a PC, that may receive and display content. The electronic device 100 may be referred to as a display device in terms of receiving and displaying content and may also be referred to as a content receiving device, a sink device, a computing device, or the like.

The source device 200 and the electronic device 100 may be connected to each other through various connection units to perform content transmission/reception. The various connection units may include, for example, a cable, and the source device 200 and the electronic device 100 may include one or more ports for cable connection. The one or more ports may include, for example, a digital input interface such as a High Definition Multimedia Interface (HDMI) port, a display port, or a Type-C. For example, each of the source device 200 and the display device 100 may include an HDMI port and may perform communication through the HDMI port. When the source device 200 provides content to the display device 100, the source device 200 may first receive Extended Display Identification Data (EDID) information provided by the electronic device 100, generate content in a format corresponding to the received EDID information, and provide the content to the electronic device 100. The EDID information may be information defining the display performance or display capability of the electronic device 100 for displaying content and may include, for example, timing information and resolution information. Thus, the source device 200 may generate a format of content to be transmitted to the electronic device 100 based on the timing information and the resolution information defined in the EDID information provided by the electronic device 100 and provide the format of the content to the electronic device 100. For example, when the EDID information provided by the electronic device 100 defines processing high resolution, the source device 200 may provide high-resolution content to the electronic device 100, and when the EDID information provided by the electronic device 100 defines processing low resolution, the source device 200 may provide low-resolution content to the electronic device 100. Through the EDID information, the source device 200 may provide the electronic device 100 with content in a format suitable for the display performance of the electronic device 100.

Moreover, the electronic device 100 may display an image of the content by operating in any one of a plurality of screen modes corresponding to different aspect ratios, for example, a horizontal mode (landscape mode) and a vertical mode (portrait mode). The horizontal mode may refer to a mode in which the width of the screen is greater than the height thereof, and the vertical mode may refer to a mode in which the height of the screen is greater than the width thereof. In order for the electronic device 100 to selectively operate according to the horizontal mode and the vertical mode, the electronic device 100 may include a driver driving the display to be rotatable, thereby controlling the driver to rotate the display in the horizontal mode or the vertical mode. For example, when there is a display rotation command while the electronic device 100 operates in the horizontal mode, the electronic device 100 may rotate the display to switch to the vertical mode, and when there is a display rotation command while the electronic device 100 operates in the vertical mode, the electronic device 100 may rotate the display to switch to the horizontal mode.

In order for the electronic device 100 to rotate the display according to the display rotation command, the display may be physically rotated and also the content displayed through the rotated display may be suitably processed (including rotation processing) and displayed, so that suitable content may be displayed on the rotated display. Suitable processing including rotation processing of the content may be performed by various methods. A first method may be a method of obtaining rotation-processed content by requesting and receiving rotation-processed content from the source device that provides the content displayed on the electronic device 100. For example, the electronic device 100 may request and receive the rotation-processed content from the source device by using an EDID system or the like. Hereinafter, the first method may be referred to as a first rotation control mode, a first mode, or an EDID change mode. Hereinafter, the first method will be mainly referred to as the EDID change mode. A second method may be a method by which the electronic device 100 rotation-processes and displays the content by using a System-On-Chip (SOC) or the like. Hereinafter, the second method may be referred to as a second rotation control mode, a second mode, or an SOC rotation mode. Hereinafter, the second method will be mainly referred to as the SOC rotation mode.

In the EDID change mode, because rotation-processed content is requested from the source device and the rotation-processed content is received from the source device, there may be no additional time consumed for content rotation processing in the electronic device 100 and therefore there may be no additional processing delay in content rotation processing. On the other hand, because not all source devices may perform content rotation processing to transmit content to the electronic device, the EDID change mode may be used when the content rotation processing is possible in the source device and may not be applied to the source device in which the content rotation processing is not possible. Because rotation- processed content is not received from the source device but content rotation processing is performed in the electronic device 100 in the SOC rotation mode, the SOC rotation mode may be used regardless of the source device. However, in the SOC rotation mode, because the electronic device 100 needs to perform content rotation processing for each frame before content display and display the result thereof on the display, a processing delay may occur due to content rotation processing. Thus, when there is a delay in content processing, it may not be suitable for the genre of content in which content playback is not natural.

As such, the EDID change mode and the SOC rotation mode may have their respective advantages and disadvantages, and the situations in which the respective modes may be used may be different from each other. Thus, in the described embodiments, the electronic device 100 may more flexibly perform a content rotation control operation by adaptively selecting one of the EDID change mode and the SOC rotation mode according to the usage environment of the electronic device 100 when there is a display rotation command.

According to an embodiment, the electronic device 100 may identify a usage environment of the electronic device when receiving a display rotation command of the electronic device, select one of an EDID change mode or a SOC rotation mode as a display rotation mode according to the identified usage environment of the electronic device, when the selected display rotation mode is the EDID change mode, perform a display rotation control operation by changing the EDID and receiving an image adjusted according to the changed EDID, and when the selected display rotation mode is the SOC rotation mode, perform a display rotation control operation by rotating and displaying a display image.

According to an embodiment, the electronic device 100 may obtain at least one of information about a type of the source device connected to the electronic device, user setting information according to a user input, or information about a type of content displayed on the electronic device so as to identify the usage environment of the electronic device.

According to an embodiment, the information about the type of the source device, the user setting information, and the information about the type of the content may be set with defined priorities, and the electronic device 100 may select one of the EDID change mode or the SOC rotation mode as the display rotation mode by considering the usage environment of the electronic device from the information with a highest priority.

According to an embodiment, the usage environment of the electronic device may include a type of the source device connected to the electronic device, and the electronic device 100 may identify the type of the source device connected to the electronic device when receiving a display rotation command of the electronic device and select the EDID change mode as the display rotation mode when the identified type of the source device is identified as an EDID-changeable device and select the SOC rotation mode as the display rotation mode when the identified type of the source device is identified as an EDID-unchangeable device.

According to an embodiment, the usage environment of the electronic device may include a type of content displayed on the electronic device, and the electronic device 100 may identify the type of the content displayed on the electronic device when receiving a display rotation command of the electronic device and select the EDID change mode as the display rotation mode when the identified type of the content is identified as content sensitive to an input lag and select the SOC rotation mode as the display rotation mode when the identified type of the content is identified as content not sensitive to an input lag.

According to an embodiment, the usage environment of the electronic device may include user setting information according to a user input, and the electronic device 100 may identify the user setting information when receiving a display rotation command of the electronic device and select one of the EDID change mode or the SOC rotation mode as the display rotation mode according to the identified user setting information.

According to an embodiment, the electronic device 100 may, when selecting the EDID change mode as the display rotation mode, change EDID of the electronic device from first EDID to second EDID, provide the second EDID to the source device and receive an image adjusted according to the second EDID from the source device, and control the adjusted image to be displayed on a display rotated according to the display rotation command.

According to an embodiment, the electronic device 100 may detect that an error has occurred in a screen display of the adjusted image displayed on the rotated display, change the display rotation mode from the EDID change mode to the SOC rotation mode according to detection of the error, and perform a display rotation control operation according to the SOC rotation mode. Accordingly, when there is a problem in the display image even after performing a display rotation control operation by selecting the EDID change mode according to the selection of the electronic device 100, the problem may be corrected by switching to the SOC rotation mode.

According to an embodiment, the electronic device 100 may detect that an error has occurred in a screen display of the adjusted image displayed on the rotated display and perform control to display a notification message to a user according to detection of the error. Accordingly, when there is a problem in the display image, the user may be guided to take a necessary action.

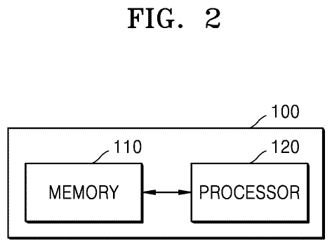

FIG. 2 is a schematic block diagram of an electronic device according to an embodiment.

Referring to FIG. 2, the electronic device 100 may include a memory 110 and a processor 120. However, the computing device 100 is not limited thereto and may include more components than the illustrated components.

According to an embodiment, the memory 110 may store one or more programs for processing and controlling by the processor 120 and may store data that is input to the electronic device 100 or output from the electronic device 100.

The memory 110 may include at least one type of storage medium from among flash memory type, hard disk type, multimedia card micro type, card type memory (e.g., SD and XD memories), random-access memory (RAM), static random-access memory (SRAM), read-only memory (ROM), electronically erasable programmable read-only memory (EEPROM), programmable read-only memory (PROM), magnetic memory, magnetic disk, and optical disk.

The processor 120 may control an overall operation of the electronic device 100. For example, the processor 120 may perform the function of the electronic device 100 described herein by executing one or more instructions stored in the memory 110.

In an embodiment of the present disclosure, by executing the one or more instructions stored in the memory 110, the processor 120 may control the above operations to be performed. In this case, the memory 110 may store one or more instructions executable by the processor 120.

Also, in an embodiment of the present disclosure, the processor 120 may store one or more instructions in an internal memory thereof and may execute the one or more instructions stored in the internal memory to perform control such that the above operations are performed. That is, the processor 120 may perform a certain operation by executing at least one instruction or program stored in the internal memory of the processor 120 or in the memory 110.

Also, although one processor 120 is illustrated in FIG. 2, a plurality of processors (not illustrated) may be provided. In this case, each of the operations performed in the electronic device according to an embodiment of the present disclosure may be performed through at least one of the plurality of processors.

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may, for example, control all operations of the electronic device 100. The processor 120 may include one or more processing circuits. For example, the processor 120 may perform functions of the electronic device 100 described in the disclosure by executing one or more instructions stored in the memory 110.

According to an embodiment, by executing the one or more instructions stored in the memory 110, the processor 120 may identify a usage environment of the electronic device when receiving a display rotation command of the electronic device, select one of an EDID change mode or a SOC rotation mode as a display rotation mode according to the identified usage environment of the electronic device, when the selected display rotation mode is the EDID change mode, perform a display rotation control operation by changing the EDID and receiving an image adjusted according to the changed EDID, and when the selected display rotation mode is the SOC rotation mode, perform a display rotation control operation by rotating and displaying a display image.

According to an embodiment, by executing the one or more instructions stored in the memory 110, the processor 120 may obtain at least one of information about a type of the source device connected to the electronic device, user setting information according to a user input, or information about a type of content displayed on the electronic device so as to identify the usage environment of the electronic device.

According to an embodiment, the information about the type of the source device, the user setting information, and the information about the type of the content may be set with predetermined priorities, and according to an embodiment, by executing the one or more instructions stored in the memory 110, the processor 120 may select one of the EDID change mode or the SOC rotation mode as the display rotation mode by considering the usage environment of the electronic device from the information with a highest priority.

According to an embodiment, the usage environment of the electronic device may include a type of the source device connected to the electronic device, and according to an embodiment, by executing the one or more instructions stored in the memory 110, the processor 120 may identify the type of the source device connected to the electronic device when receiving a display rotation command of the electronic device and select the EDID change mode as the display rotation mode when the identified type of the source device is identified as an EDID-changeable device and select the SOC rotation mode as the display rotation mode when the identified type of the source device is identified as an EDID-unchangeable device.

According to an embodiment, the usage environment of the electronic device may include a type of content displayed on the electronic device, and according to an embodiment, by executing the one or more instructions stored in the memory 110, the processor 120 may identify the type of the content displayed on the electronic device when receiving a display rotation command of the electronic device and select the EDID change mode as the display rotation mode when the identified type of the content is identified as content sensitive to an input lag and select the SOC rotation mode as the display rotation mode when the identified type of the content is identified as content not sensitive to an input lag.

According to an embodiment, the usage environment of the electronic device may include user setting information according to a user input, and according to an embodiment, by executing the one or more instructions stored in the memory 110, the processor 120 may identify the user setting information when receiving a display rotation command of the electronic device and select one of the EDID change mode or the SOC rotation mode as the display rotation mode according to the identified user setting information.

According to an embodiment, by executing the one or more instructions stored in the memory 110, the processor 120 may, when selecting the EDID change mode as the display rotation mode, change EDID of the electronic device from first EDID to second EDID, provide the second EDID to the source device and receive an image adjusted according to the second EDID from the source device, and control the adjusted image to be displayed on a display rotated according to the display rotation command.

According to an embodiment, by executing the one or more instructions stored in the memory 110, the processor 120 may detect that an error has occurred in a screen display of the adjusted image displayed on the rotated display, change the display rotation mode from the EDID change mode to the SOC rotation mode according to detection of the error, and perform a display rotation control operation according to the SOC rotation mode. Accordingly, when there is a problem in the display image even after performing a display rotation control operation by selecting the EDID change mode according to the selection of the electronic device 100, the problem may be corrected by switching to the SOC rotation mode.

According to an embodiment, by executing the one or more instructions stored in the memory 110, the processor 120 may detect that an error has occurred in a screen display of the adjusted image displayed on the rotated display and perform control to display a notification message to a user according to detection of the error. Accordingly, when there is a problem in the display image, the user may be guided to take a necessary action.

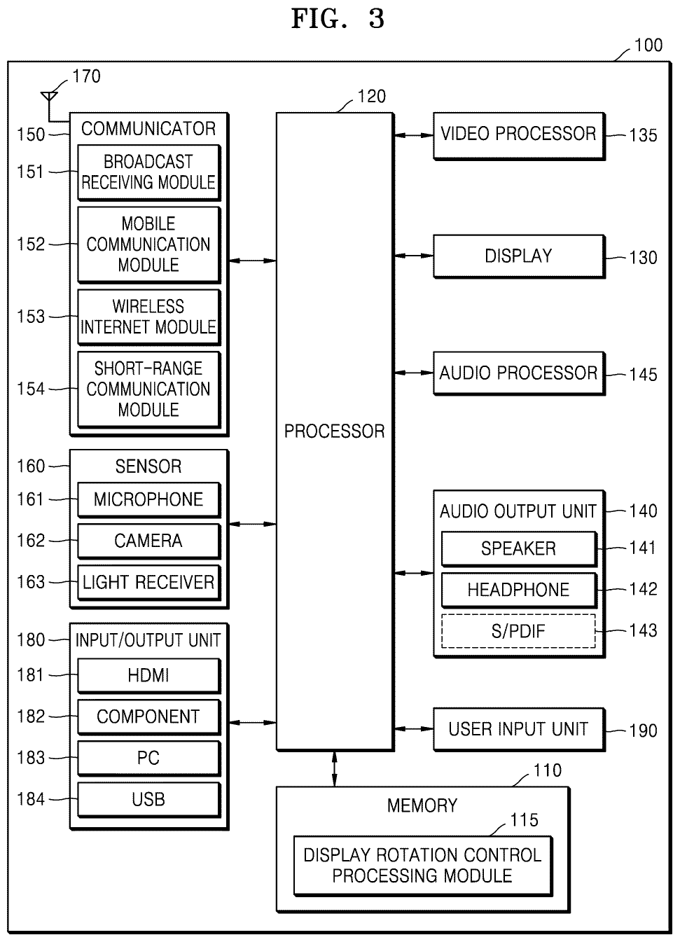

FIG. 3 is a detailed block diagram of an electronic device according to an embodiment.

In FIG. 3, the same components as those in FIG. 2 are denoted by the same reference symbols. Thus, in describing the electronic device 100, redundant descriptions overlapping with those in FIG. 2 will be omitted for conciseness.

Referring to FIG. 3, in addition to the memory 110 and the processor 120, the electronic device 100 may further include a display 130, an antenna 170, a communicator 150, a sensor 160, an input/output unit 180, a video processor 135, an audio processor 145, an audio output unit 140, and a user input unit 190.

As for the memory 110 and the processor 120, the same descriptions as those in FIG. 2 will be omitted in FIG. 3.

The display 130 may display an image on the screen under the control by the processor 120. The image displayed on the screen may be received from the communicator 150, the input/output unit 180, and the memory 110.

According to an embodiment, the display 130 may be rotated according to the control by the processor 120. In order to control the rotation of the display 130, the electronic device 100 may further include a display driver, and the display 130 may be rotated, for example, by 90 degrees according to the control by the display driver. For example, the display 130 may be rotated to operate in the vertical mode according to a display rotation command while operating in the horizontal mode and may be rotated to operate in the horizontal mode according to a display rotation command while operating in the vertical mode.

The transmitting/receiving antenna 170 may receive signals transmitted by other devices or transmit signals to the other devices. Although one transmitting/receiving antenna 170 is illustrated, a plurality of antennas may be included therein. Thus, the electronic device according to the present disclosure may support a Multiple Input Multiple Output (MIMO) system.

The communicator 150 may include one or more modules for enabling wireless communication between the electronic device 100 and a wireless communication system or between the electronic device 100 and a network in which other electronic devices are located. For example, the communicator 150 may include a broadcast receiving module 151, a mobile communication module 152, a wireless Internet module 153, and a short-range communication module 154. The communicator 150 may be referred to as a transmitter/receiver.

The broadcast receiving module 151 may receive broadcast signals and/or broadcast-related information from an external broadcast management server on broadcast channels. The broadcast signals may include not only a TV broadcast signal, a radio broadcast signal, and a data broadcast signal but also a broadcast signal in which a data broadcast signal is combined with a TV broadcast signal or a radio broadcast signal.

The mobile communication module 152 may transmit/receive wireless signals to/from at least one of a base station, an external terminal, or a server on a mobile communication network. The wireless signals may include voice call signals, video call signals, or various types of data according to transmission/reception of text/multimedia messages.

The wireless Internet module 153 may refer to a module for wireless Internet access and may be installed inside or outside a device. Wireless LAN (WLAN) (WiFi), Wireless Broadband (WiBro), World Interoperability for Microwave Access (WiMAX), High Speed Downlink Packet Access (HSDPA), or the like may be used as wireless Internet technology. Through the wireless Internet module 153, the device may establish a WiFi peer-to-peer (P2P) connection with another device. A streaming service between devices may be provided through the WiFi P2P connection, and a printing service may be provided by connecting with a printer or transmitting/receiving data.

The short-range communication module 154 may refer to a module for short-range communication. Bluetooth, Radio Frequency Identification (RFID), Infrared Data association (IrDA), Ultra Wideband (UWB), ZigBee, or the like may be used as the short-range communication technology.

According to an embodiment, the communicator 150 may receive content from an external server.

The sensor 160 may sense the user's voice, the user's image, or the user's interaction and may include a microphone 161, a camera 162, and a light receiver 163.

The microphone 161 may receive the user's utterance voice. The microphone 161 may convert the received voice into an electrical signal and output the electrical signal to the processor 120.

The camera 162 may receive an image (e.g., consecutive frames) corresponding to the user's motion including a gesture within a camera recognition range.

The light receiver 163 may receive a light signal (including a control signal) received from a remote controller. The light receiver 163 may receive a light signal corresponding to a user input (e.g., touch, press, touch gesture, voice, or motion) from the remote controller. The control signal may be extracted from the received light signal under the control by the processor 120.

The input/output unit 180 may receive, for example, a video (e.g., moving image), an audio (e.g., voice and music), and additional information (e.g., Electronic Program Guide (EPG)) from outside the electronic device 100 under the control by the processor 120. The input/output unit 180 may include one of a High-Definition Multimedia Interface (HDMI) port 181, a component jack 182, a PC port 183, and a Universal Serial Bus (USB) port 184. The input/output unit 180 may include any combination of the HDMI port 181, the component jack 182, the PC port 183, and the USB port 184.

According to an embodiment, the input/output unit 180 may provide EDID to the source device 200 and receive an image formatted according to the EDID from the source device 200.

According to an embodiment, the memory 110 may store one or more programs for processing and controlling by the processor 120 and may store data that is input to the electronic device 100 or output from the electronic device 100. Also, the memory 110 may store data necessary for the operation of the electronic device 100.

Also, the programs stored in the memory 110 may be classified into a plurality of modules according to the functions thereof. For example, the one or more programs stored in the memory 110 may include a display rotation control processing module 115. The display rotation control processing module 115 may include one or more instructions for performing the operations of the electronic device 100 described herein that are performed according to a display rotation command.

The processor 120 may control an overall operation of the electronic device 100 and a signal flow between the internal components of the electronic device 100 and perform a data processing function. When there is a user's input or a preset stored condition is satisfied, the processor 120 may execute various applications and an operating system (OS) stored in the memory 110.

Also, the processor 120 may include an internal memory. In this case, at least one of the data, programs, and instructions stored in the memory 110 may be stored in the internal memory of the processor 120.

According to an embodiment, the processor 120 may perform the display rotation control processing of the electronic device 100 described herein by executing the one or more instructions included in the display rotation control processing module 115 stored in the memory 110.

The video processor 135 may process image data to be displayed by the display 130 and perform various image processing operations such as decoding, rendering, scaling, noise reduction, frame rate conversion, and resolution conversion on the image data.

The audio processor 145 may perform processing on audio data. The audio processor 145 may perform various processings such as decoding, amplification, and noise reduction on the audio data.

Under the control by the processor 120, the audio output unit 140 may output the audio included in the broadcast signal received through a tuner 170, the audio input through the communicator 150 or the input/output unit 180, or the audio stored in the memory 110. The audio output unit 140 may include at least one of a speaker 141, a headphone output terminal 142, or a Sony/Philips Digital Interface (S/PDIF) output terminal 143.

The user input unit 190 may refer to a unit through which the user inputs data for controlling the electronic device 100. For example, the user input unit 190 may include a keypad, a dome switch, a touch pad, a jog wheel, and/or a jog switch but is not limited thereto.

In an embodiment, one or more components among the memory 110, the processor 120, the communicator 150, the sensor 160, the input/output unit 180, the video processor 135, and the audio processor 145 may be included in a system-in-package or system-in-chip device.

Moreover, the block diagram of the electronic device 100 illustrated in FIG. 2 or 3 may be a block diagram for an embodiment. Each component of the block diagram may be integrated, added, or omitted according to the specifications of the electronic device 100 that are actually implemented. For example, when necessary, two or more components may be combined into one component, or one component may be divided into two or more components. Also, a function performed in each block is to describe embodiments, and a particular operation or device thereof is not intended to limit the scope of the present disclosure.

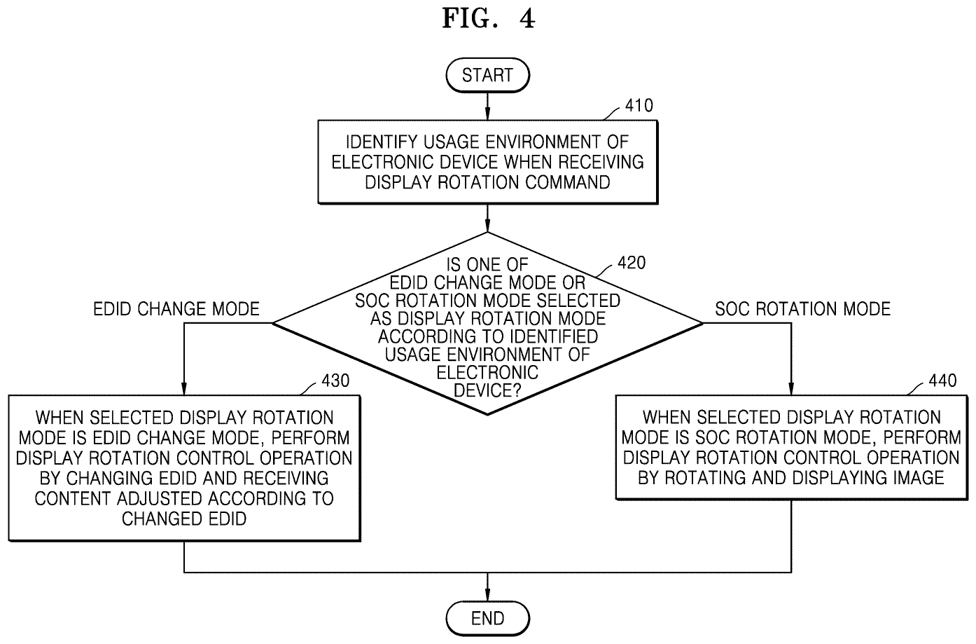

FIG. 4 illustrates an example of an operation method of an electronic device operating according to a display rotation command, according to an embodiment.

Referring to FIG. 4, in operation 410, the electronic device 100 may identify a usage environment of the electronic device 100 when receiving a display rotation command.

According to an embodiment, the electronic device 100 may receive a display rotation command when receiving a user input for commanding display rotation. For example, the user may input a display rotation command when the user wants to switch the display mode from the horizontal mode to the vertical mode or from the vertical mode to the horizontal mode.

According to an embodiment, the electronic device 100 may obtain a display rotation command according to internal system determination. For example, the electronic device 100 may recognize content suitable for display in the vertical mode while operating in the horizontal mode and obtain a display rotation event according to the recognition, or may recognize content suitable for display in the horizontal mode while operating in the vertical mode and obtain a display rotation event according to the recognition.

According to an embodiment, the electronic device 100 may identify the usage environment of the electronic device 100 when receiving the display rotation command. Particularly, the usage environment of the electronic device 100 may include at least one of a type of the source device connected to the electronic device 100, a type of the content displayed on the electronic device 100, or user setting information.

According to an embodiment, the usage environment of the electronic device 100 may include the type of the source device connected to the electronic device 100. The source device may refer to a device that is communicatively connected to the electronic device to provide or transmit content to the electronic device 100. The type of the source device may be divided into a device that may change the content format in response to a request from the electronic device 100 and a device that may not change the content format. The source device that may change the content format may refer to a device that receives a content format change request from the electronic device 100, processes a content format change in response to the content format change request, and provides the result thereof to the electronic device 100. The source device that may not change the content format may refer to a device that may not process a content format change request from the electronic device 100. For example, the content format may include EDID. The EDID may be information for informing the source device of video/audio format specification information that may be supported by the electronic device 100, and the electronic device 100 may be connected to the source device providing the content, to provide the stored EDID to the source device when there is a request from the source device. The source device that has received the EDID may process the format of the content based on the EDID received from the electronic device and provide the processed content to the electronic device.

In this case, the source device that may change the content format may refer to a device that may receive the changed EDID from the electronic device 100, change the content format according to the changed EDID, and provide the result thereof to the electronic device 100. The source device that may not change the content format may refer to a device that may not transmit/receive EDID information to/from the electronic device 100.

According to an embodiment, the usage environment of the electronic device 100 may include the type of the content displayed on the electronic device 100. The type of the content may include first type content and second type content. Particularly, the type of the content may be classified into content sensitive to an input lag (the first type content) and content not sensitive to an input lag (the second type content) depending on whether it is sensitive to an input lag.

A time delay that occurs after a key is input for controlling execution of the content until a response corresponding to the input key is displayed on the screen may be referred to as an input lag, and the delay felt by the user may increase as the time difference thereof increases. The input lag may not only include the time required for image quality processing such as decoding speed in the electronic device 100 but also include the time required for the server computer to process the content in order to transmit the content to the electronic device 100 and the time required for the content to be transmitted from the server computer to the electronic device, or the like, when the content requested to be executed is the content displayed by a real-time bidirectional communication service with the server computer.

For example, game content provided by a real-time bidirectional communication service may be categorized based on the latency impact. For example, a role playing game (RPG) may refer to a role playing game in which users enjoy playing as characters in the game. An MMORPG may be an abbreviation for a Massive Multiplayer Online Role Playing Game, and the MMORPG may be a type of RPG in which users play as characters in the game and may refer to a game in which multiple players connected online may simultaneously play in the same space. Although the MMORPG is a type of RPG, it may be important to have the minimal latency because simultaneity with other users is important. A first-person shooting game (first-person shooter (FPS)) refers to a shooting game in which a player uses weapons or tools to fight on a screen in the player's viewpoint, i.e. as if I am looking at an object, and has the advantage of high realism compared to other games because the viewpoint of the character in the game and the player's viewpoint are the same. In the case of a shooting game, it may be important to have the minimal latency even when there is a disconnection, because the viewpoint of the character in the game and the player's viewpoint need to be the same for the shooting to be accurately implemented. On the other hand, in the case of an RPG played alone, it may be more important to play without disconnection than to have the minimum latency. Thus, the RPG may be included in the category with low latency impact (second type content), and the game such as FPS or MMORPG may be included in the category with high latency impact (first type content).

According to an embodiment, the usage environment of the electronic device 100 may include the user setting information. Particularly, the electronic device 100 may store user setting information about whether to process according to the EDID change mode or according to the SOC rotation mode when performing a display rotation operation and may obtain the user setting information when there is a display rotation command.

In operation 420, the electronic device 100 may select one of the EDID change mode or the SOC rotation mode as the display rotation mode according to the identified usage environment of the electronic device.

According to an embodiment, the electronic device 100 may select one of the EDID change mode or the SOC rotation mode as the display rotation mode according to one of the usage environments identified in operation 410.

According to an embodiment, when the usage environment identified in operation 410 is the type of the source device connected to the electronic device 100, the electronic device 100 may select one of the EDID change mode or the SOC rotation mode as the display rotation mode according to the type of the source device. Particularly, when the type of the source device is a device that may change the content format, the electronic device 100 may select the EDID change mode, and when the type of the source device is a device that may not change the content format, the electronic device 100 may select the SOC rotation mode.

According to an embodiment, when the usage environment identified in operation 410 is the type of the content, the electronic device 100 may select one of the EDID change mode or the SOC rotation mode as the display rotation mode according to the type of the content. Particularly, when the type of the content is a type sensitive to an input lag, the electronic device 100 may select the EDID change mode, and when the type of the content is a type not sensitive to an input lag, the electronic device 100 may select the SOC rotation mode.

According to an embodiment, when the usage environment identified in operation 410 is the user setting information, the electronic device 100 may select one of the EDID change mode or the SOC rotation mode as the display rotation mode according to the user setting information. Particularly, when the user setting information represents the EDID change mode, the electronic device 100 may select the EDID change mode, and when the user setting information represents the SOC rotation mode, the electronic device 100 may select the SOC rotation mode.

According to an embodiment, the electronic device 100 may give priority to the usage environment identified in operation 410 and select one of the EDID change mode or the SOC rotation mode as the display rotation mode according to the priority. When there are a plurality of usage environments identified in operation 410, the electronic device 100 may not use only one usage environment but may give priorities to the usage environments and perform determination by first considering the usage environment with the highest priority according to the priorities. For example, among the usage environments, the electronic device 100 may consider the type of the source device with the highest priority, consider the user setting information with the second priority in consideration of the user's intention, and consider the type of the content with the last priority. However, the priorities may be determined in various ways.

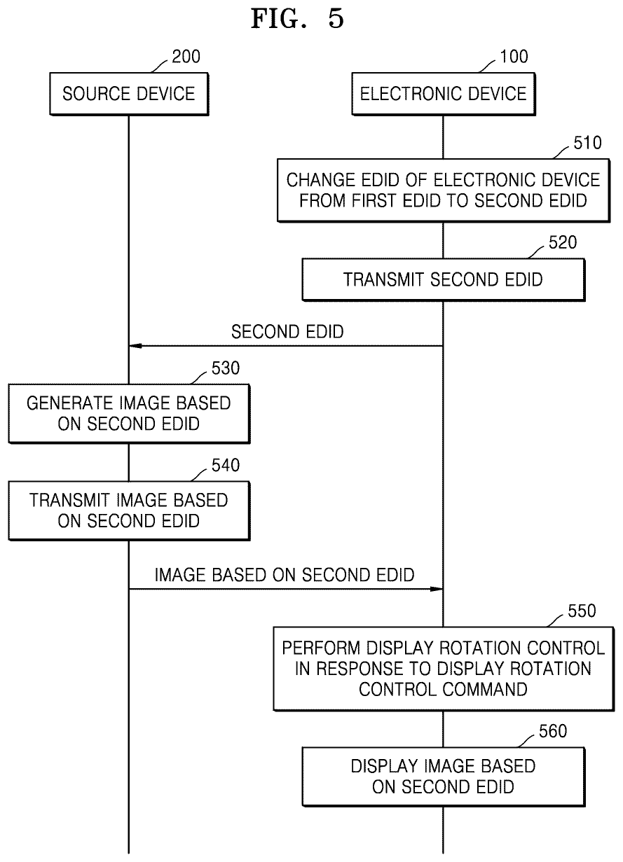

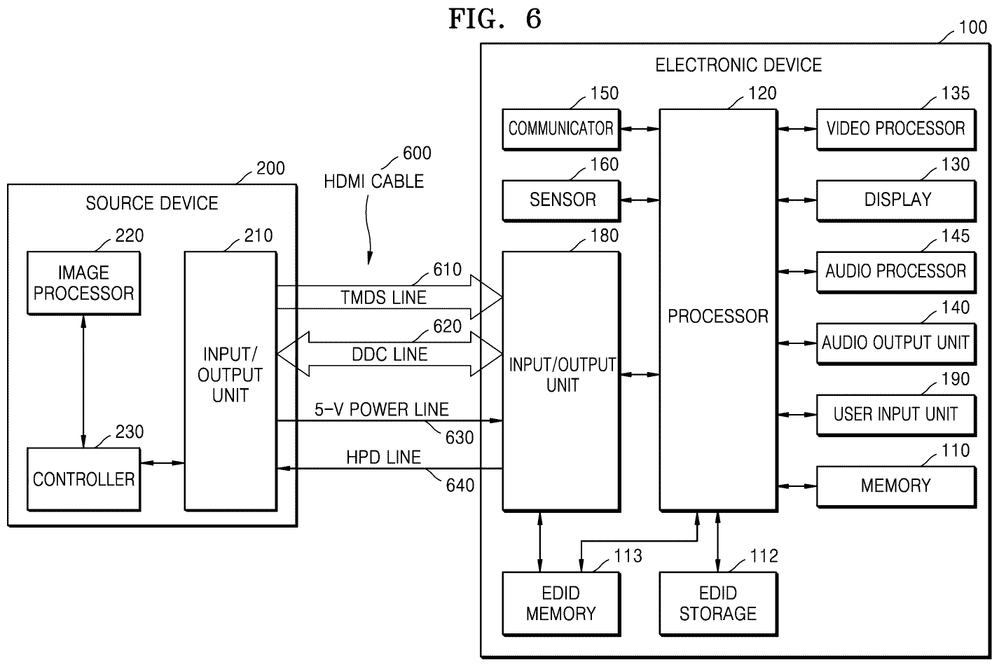

In operation 430, when the selected display rotation mode is the EDID change mode, the electronic device 100 may perform a display rotation control operation by changing the EDID and receiving content adjusted according to the changed EDID. The EDID change mode may refer to a mode in which the source device performs image rotation processing according to a display rotation command and the electronic device receives and displays a rotation-processed image from the source device. In the EDID change mode, because the electronic device receives a rotation-processed image from the source device according to the display rotation and only functions to display the rotation-processed image, no separate rotation processing time may be required in the electronic device. Thus, an input lag problem may not occur, and High Frequency Rate/Variable Refresh Rate (HFR/VRR) setting may be possible without resolution restriction even in the vertical mode. That is, in the case where the electronic device 100 itself rotation-processes the content in the vertical mode of the electronic device 100, it may be difficult to process HFR/VRR or the like due to the scaler restriction in the electronic device 100; however, in the EDID change mode, because a rotation-processed content is received from the source device, there may be no restriction in processing the HFR/VRR or the like. However, in the EDID change mode, there may be a case where the user needs to manually set the vertical mode on the source device (in the case of a PC), and there may be a device in which EDID change is not possible depending on the type of the source device. The display rotation control operation according to the EDID change mode will be described in detail with reference to FIGS. 5 and 6.

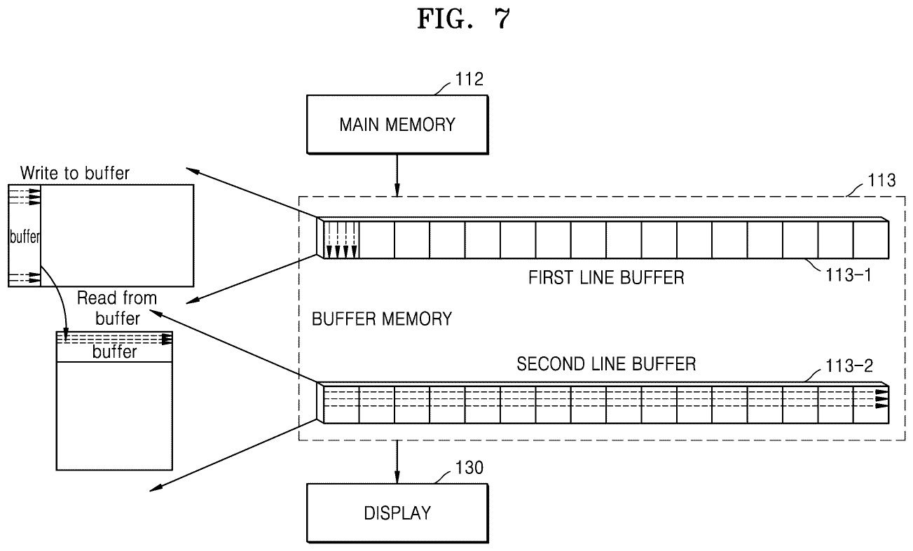

In operation 440, when the selected display rotation mode is the SOC rotation mode, the electronic device 100 may perform a display rotation control operation by rotating and displaying an image. The SOC rotation mode may refer to a mode in which the SOC in the electronic device 100 performs rotation processing of an image according to the display rotation. In the SOC rotation mode, because a separate request for display rotation is not transmitted to the source device providing the content, automatic conversion may be possible without additional user setting, and because rotation processing is performed in the electronic device 100, it may be applied without limitation to the type of the source device that is connected to the electronic device 100 to provide the content. However, in the SOC rotation mode, because a processing system in the electronic device 100 needs to perform rotation processing for each frame of the content received from the source device, the processing time may be long. Thus, the input lag may increase, and an HFR/VRR operation for a 4K input in the vertical mode may be impossible. The display rotation control operation according to the SOC rotation mode will be described in detail with reference to FIG. 7.

FIG. 5 is a flowchart of a method by which an electronic device performs a display rotation control operation according to an EDID change mode, according to an embodiment.

Referring to FIG. 5, in operation 510, the electronic device 100 may change the EDID of the electronic device 100 from first EDID to second EDID. According to a display rotation command, the display that has been operating in the horizontal mode may be switched to the vertical mode. In this case, the first EDID set according to the resolution of the horizontal mode may need to be changed to the second EDID according to the vertical mode such that an image may be displayed corresponding to the resolution of the vertical mode. The display that has been operating in the vertical mode may be switched to the horizontal mode. In this case, the first EDID set according to the resolution of the vertical mode may need to be changed to the second EDID according to the horizontal mode such that an image may be displayed corresponding to the resolution of the horizontal mode. For example, in a case where the first EDID is 32:9 when operating in the horizontal mode, when switching to the vertical mode according to a display rotation command, the EDID needs to be changed to the second EDID, which is 9:32, according to the vertical mode in order to receive a corresponding image from the source device.

In operation 520, the electronic device 100 may transmit the second EDID to the source device.

In operation 530, the source device 200 may receive the second EDID from the electronic device 100 and process the image format of the content based on the received second EDID.

In operation 540, the source device 200 may transmit the content with the image format processed based on the second EDID to the electronic device 100.

In operation 550, the electronic device 100 may perform display rotation control in response to a display rotation control command. For example, during the horizontal mode operation of the display, the display may be controlled and rotated to operate in the vertical mode according to a display rotation control command, and during the vertical mode operation of the display, the display may be controlled and rotated to operate in the horizontal mode according to a display rotation control command.

In operation 560, the electronic device 100 may display an image based on the second EDID received from the source device 100 on the rotation-controlled display.

In the case of receiving and displaying the content with the image format processed based on the changed EDID, because the electronic device 100 does not require separate internal processing due to the display rotation, additional time may not be required for content processing and display and thus the content may be displayed without affecting the content processing speed.

FIG. 6 is a reference diagram for describing an electronic device performing a display rotation control operation according to an EDID change mode, according to an embodiment.

The EDID may be a standardized means for the electronic device to transmit its display performance information to the source device. Through the EDID, the electronic device may transmit operation characteristics such as basic resolution or recommended resolution to the connected source device and cause the source device to generate a format of content necessary to satisfy the requirements of the electronic device.

An EDID block including the EDID may include a header including a fixed pattern indicating an EDID file, display product identification information, EDID version information, basic display parameters defining characteristics such as basic video timing, color characteristics defining RGB color space conversion technology used in the display device, detailed timing information of the resolution supported by the display device, or the like.

The electronic device 100 may record the changed EDID in a memory that may be accessed and read by the source device 200. The electronic device 100 may change the EDID and use the result thereof whenever an event requiring to change the EDID occurs, or may store the changed EDID together with the original EDID and select and use the stored changed EDID when having to use the changed EDID.

Referring to FIG. 6, the source device 200 may include an input/output unit 210, an image processor 220, and a controller 230.

The input/output unit 210 may output an image signal of a resolution that may be processed by the electronic device 100 and an audio signal of a sound format that may be processible. Also, the input/output unit 210 may read the EDID including display characteristic information including information about a supportable resolution or sound format from the electronic device 100.

The input/output unit 210 may include one or more ports for communication with the electronic device 100. For example, the one or more ports may include ports of various standards such as HDMI port, DisplayPort (DP), Thunderbolt, Mobile High-Definition Link (MHL), and USB.

The image processor 220 may process an image to be transmitted through the input/output unit 210 under the control by the controller 230.

The controller 230 may control an overall operation of the source device 200, control the processing of image signals and audio signals to be transmitted to the electronic device 100, and control the output of the processed image signals and audio signals through the input/output unit 210.

According to an embodiment, the controller 230 may read the EDID including the display characteristic information from the electronic device 100 and control the image processor 220 to process an image based on the read EDID.

According to an embodiment, the controller 230 may read the EDID from the electronic device 100 according to the connection between the source device 200 and the electronic device 100, control the image processor 220 to process an image based on the read EDID, and control the processed image signal to be transmitted to the electronic device 100 through the input/output unit 210.

The electronic device 100 will now be described.

The electronic device 100 may process and output video signals and audio signals received from the source device 200.

Under the control by the processor 120, the input/output unit 180 may receive the video signals and audio signals received from the source device 200 according to a connected protocol and output the same to the video processor 135 and the audio processor 145.

An EDID storage 112 may be a memory storing EDID and may store EDID data including display characteristic information such as a manufacturer/product identifier, an EDID format version, display parameters (supportable resolution, color format, and the like), and an audio format. The EDID may be stored in the EDID storage 112 by the manufacturer during the manufacturing process of the electronic device 100. A flash memory may be used as the EDID storage 112.

The EDID storage 112 may store EDID corresponding to each port corresponding to one or more ports included in the input/output unit 180 of the electronic device 100. For example, when the input/output unit 180 includes an HDMI port and a display port, the EDID storage 112 may include EDID used for the HDMI port and EDID used for the display port.

According to an embodiment, the processor 120 may record the EDID stored in the EDID storage 112 into the EDID memory 113 so that the EDID may be read by the source device 200. The EDID memory 113 from which the source device 200 may read the EDID may be implemented as an Electrically Erasable Programmable Read-Only Memory (EEPROM).

According to an embodiment, in order to improve the EDID compatibility, instead of intactly recording the EDID stored in the EDID storage 112 into the EDID memory 113, the processor 120 may change the EDID and record the changed EDID in the EDID memory 113. In order to distinguish from the changed EDID, the EDID stored during the manufacturing process of the electronic device 100 may be referred to as first EDID, and the EDID changed and generated by the processor 120 according to the display rotation command may be referred to as second EDID.

According to an embodiment, when it is necessary to change the resolution of the display according to the display rotation command, the processor 120 may change the first EDID to the second EDID and store the second EDID in the EDID memory 113.

The input/output unit 210 of the source device 200 and the input/output unit 180 of the electronic device 100 may be connected through one or more cables. A communication process in the case where the input/output unit 210 of the source device 200 and the input/output unit 180 of the electronic device 100 are connected through an HDMI cable will be described with reference to FIG. 6.

Referring to FIG. 6, an HDMI cable 600 may include a Transition Minimized Differential Signaling (TMDS) line 610 for transmitting video signals and audio signals, a Display Data Channel (DDC) line 620 for transmitting EDID data, a 5-V power line 630 for providing a 5-V voltage from the source device 200 to the electronic device 100, and a Hot Plug Detect (HPD) line 640 for controlling EDID readout.

As for an operation in the case where the source device 200 and the electronic device 100 are connected by the HDMI cable, first, when the source device 200 and the electronic device 100 are connected by the HDMI cable, the input/output unit 210 of the source device 200 may provide a 5-V voltage to the input/output unit 180 of the electronic device 100 through the 5-V power line 630. The input/output unit 180 of the electronic device provided with the 5 volt voltage may transmit a signal with a high-level voltage to the input/output unit 210 of the source device 200 through the HPD line 640. The input/output unit 210 of the source device 200, which has received the signal with a high-level voltage through the HPD line 640, may transmit an EDID request signal through the DDC line 620, and the input/output unit 180 of the electronic device 100, which has received the EDID request signal, may provide the EDID of the electronic device 100 to the input/output unit 210 of the source device 200. The controller 230 of the source device 200, which has received the EDID of the electronic device 100, may parse the EDID to obtain the display characteristic information and perform control to perform content processing based on the obtained display characteristic information. The input/output unit 210 of the source device 200 may transmit the processed image signal and audio signal to the input/output unit 180 of the electronic device 100 through the TMDS line 610.

The source device 200 may determine whether a voltage level of an HPD signal is a high level higher than or equal to a preset voltage level, and when the voltage level is a high level, the source device 200 may read the EDID data from the electronic device 100 according to the inter-IC (I2C) bus protocol. Thus, by controlling the HPD line 640, the electronic device 100 may control the source device 200 to read its own EDID. Particularly, when an EDID change operation is required, the electronic device 100 may prevent the source device 200 from reading the EDID signal by maintaining the HPD line 640 at a low level while the electronic device 100 changes the EDID, and when the EDID change is completed, the electronic device 100 may control the source device 200 to read the changed EDID by making the HPD line 640 at a high level.

According to an embodiment, when there is a display rotation command, the electronic device 100 may perform display rotation control and in this case, may perform an EDID change operation to reflect the resolution of the rotated display, and in this case, the electronic device 100 may prevent the source device 200 from reading the EDID signal by maintaining the HPD line 640 at a low level while performing the EDID change operation, and when the EDID change is completed, the electronic device 100 may control the source device 200 to read the changed EDID by making the HPD line 640 at a high level.

FIG. 7 is a reference diagram for describing an operation of rotating and displaying an image in an SOC rotation mode, according to an embodiment.

Hardware and/or firmware for performing an image rotation operation in the SOC rotation mode may be completely or partially implemented by any programmable or hard-coded logic, for example, a field programmable gate array (FPGA), a transistor-transistor-logic (TTL), or an application-specific integrated circuit (ASIC).

According to an embodiment, when the electronic device 100 rotates and displays the image received from the source device, the image rotation may be performed by a dual-line memory buffer method.

Because the electronic device 100 needs to continuously display an image in a raster scan manner and the image needs to be rotated and read, all of data needs to be written into one line buffer memory such that the data may be read.

Referring to FIG. 7, the display 130 needs to continuously display an image in a raster scan order, and for this purpose, a rotated image needs to be previously written into a buffer memory 113. Also, for a real-time display operation, while the display 130 reads data of a certain size from a second line buffer memory 113-2 among the line buffer memories included in the buffer memory 113, the data of a certain size needs to be read from a main memory 112 and written into a first line buffer memory 113-1 among the line buffer memories included in the buffer memory 113. Thus, the buffer memory 113 may include two line buffer memories (113-1, 113-2) to use a method of writing a rotated image into another line buffer memory while an image is read from one line buffer memory.

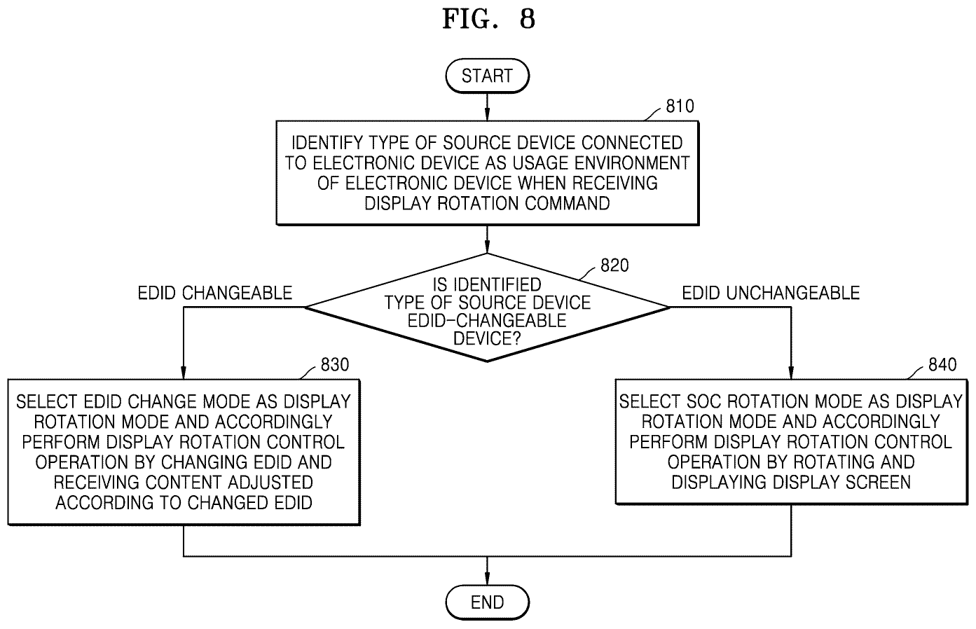

FIG. 8 illustrates an example of an operation method of an electronic device operating according to a display rotation command, according to an embodiment.

Referring to FIG. 8, in operation 810, when receiving a display rotation command, the electronic device 100 may identify the type of the source device connected to the electronic device as the usage environment of the electronic device 100.

The source device may refer to a device that is communicatively connected to the electronic device to provide or transmit content to the electronic device 100. The type of the source device may be divided into a device that may change the content format in response to a request from the electronic device 100 and a device that may not change the content format. The source device that may change the content format may refer to a device that receives a content format change request from the electronic device 100, processes a content format change in response to the content format change request, and provides the result thereof to the electronic device 100. The source device that may not change the content format may refer to a device that may not process a content format change request from the electronic device 100. For example, the content format may include EDID. The EDID may be information for informing the source device of video/audio format specification information that may be supported by the electronic device 100, and the electronic device 100 may be connected to the source device providing the content, to provide the stored EDID to the source device when there is a request from the source device. The source device that has received the EDID may process the format of the content based on the EDID received from the electronic device and provide the processed content to the electronic device. In this case, the source device that may change the content format may refer to a device that may receive the changed EDID from the electronic device 100, change the content format according to the changed EDID, and provide the result thereof to the electronic device 100. The source device that may not change the content format may refer to a device that may not transmit/receive EDID information to/from the electronic device 100.

In operation 820, the electronic device 100 may determine whether the identified type of the source device is an EDID-changeable device. The electronic device 100 may previously identify the source device of an EDID-changeable type. When the electronic device 100 is connected to the source device to receive content, the electronic device 100 may receive identification information of the connected source device and may identify whether the type of the source device is an EDID-changeable device, based on the received identification information of the source device. For example, an EDID-changeable source device may include a PC, and an EDID-unchangeable source device may include a server computer. A console game device may be EDID-changeable or EDID-unchangeable depending on the specifications thereof.

As a result of the determination in operation 820, when the identified type of the source device is an EDID-changeable device, the operation method may proceed to operation 830, and when the identified type of the source device is an EDID-unchangeable device, the operation method may proceed to operation 840.

In operation 830, when the identified type of the source device is an EDID-changeable device, the electronic device 100 may select the EDID change mode as the display rotation mode, and accordingly, the electronic device 100 may perform a display rotation control operation by changing the EDID and receiving content adjusted according to the changed EDID. The display rotation control operation according to the EDID change mode has been described above with reference to FIGS. 5 and 6.

In operation 840, when the identified type of the source device is an EDID-unchangeable device, the electronic device 100 may select the SOC rotation mode as the display rotation mode, and accordingly, the electronic device 100 may perform a display rotation control operation by rotating and displaying an image. The display rotation control operation according to the SOC rotation mode has been described above with reference to FIG. 7.

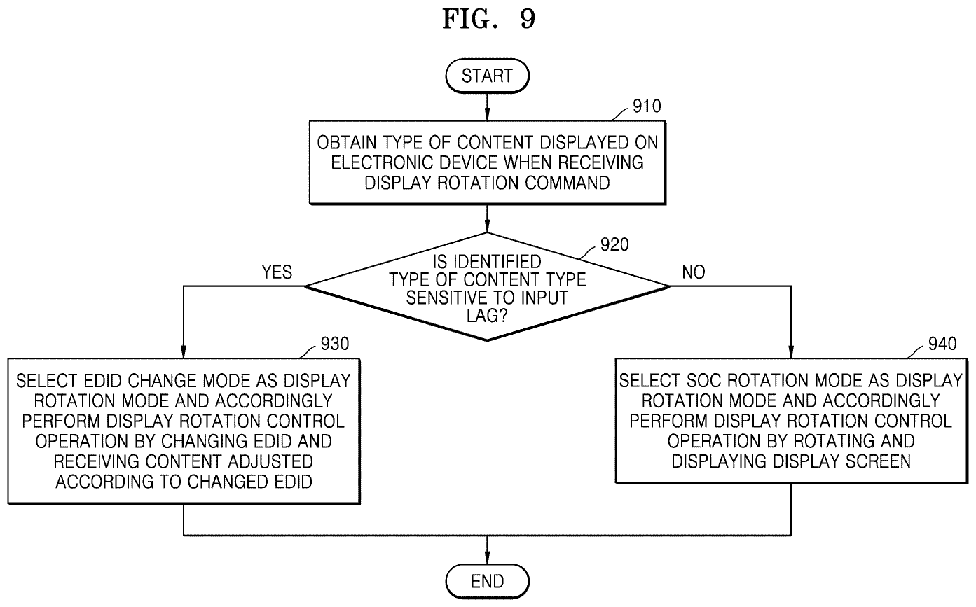

FIG. 9 illustrates an example of an operation method of an electronic device operating according to a display rotation command, according to an embodiment.

Referring to FIG. 9, in operation 910, when receiving a display rotation command, the electronic device 100 may obtain the type of the content displayed on the electronic device as the usage environment of the electronic device 100.

In operation 920, the electronic device 100 may determine whether the identified type of the content is content sensitive to an input lag. The type of the content may be classified into content sensitive to an input lag and content not sensitive to an input lag, depending on whether it is sensitive to an input lag.

A time delay that occurs after a key is input for controlling execution of the content until a response corresponding to the input key is displayed on the screen may be referred to as an input lag, and the delay felt by the user may increase as the time difference thereof increases. The input lag may not only include the time required for image quality processing such as decoding speed in the electronic device 100 but also include the time required for the server computer to process the content in order to transmit the content to the electronic device 100 and the time required for the content to be transmitted from the server computer to the electronic device, or the like, when the content requested to be executed is the content displayed by a real-time bidirectional communication service with the server computer.

For example, game content provided by a real-time bidirectional communication service may be categorized based on the latency impact. For example, an RPG may refer to a role playing game in which users enjoy playing as characters in the game. An MMORPG may be an abbreviation for a Massive Multiplayer Online Role Playing Game, and the MMORPG may be a type of RPG in which users play as characters in the game and may refer to a game in which multiple players connected online may simultaneously play in the same space. Although the MMORPG is a type of RPG, it may be important to have the minimal latency because simultaneity with other users is important. A first-person shooting game (first-person shooter (FPS)) refers to a shooting game in which a player uses weapons or tools to fight on a screen in the player's viewpoint, i.e., as if I am looking at an object, and has the advantage of high realism compared to other games because the viewpoint of the character in the game and the player's viewpoint are the same. In the case of a shooting game, it may be important to have the minimal latency even when there is a disconnection, because the viewpoint of the character in the game and the player's viewpoint need to be the same for the shooting to be accurately implemented. On the other hand, in the case of an RPG played alone, it may be more important to play without disconnection than to have the minimum latency. Thus, the RPG may be included in the category with low latency impact, and the game such as FPS and MMORPG may be included in the category with high latency impact.

As a result of the determination of operation 920, when the identified type of the content is a type sensitive to an input lag, the operation method may proceed to operation 930, and when the identified type of the content is not a type sensitive to an input lag, the operation method may proceed to operation 940.

In operation 930, when the identified type of the content is a type sensitive to an input lag, the electronic device 100 may select the EDID change mode as the display rotation mode. In the EDID change mode, because the content with the format changed corresponding to the display rotation is received from the source device, no additional delay time is required for processing the content in the electronic device and therefore the content may be processed without an input lag.

When the EDID change mode is selected as the display rotation mode, the electronic device 100 may perform a display rotation control operation by changing the EDID and receiving content adjusted according to the changed EDID. The display rotation control operation according to the EDID change mode has been described above with reference to FIGS. 5 and 6. In operation 940, when the identified type of the content is not a type sensitive to an input lag, the electronic device 100 may select the SOC rotation mode as the display rotation mode. In the SOC rotation mode, because the image rotation operation may also be performed in the electronic device according to the display rotation, a delay time may be consumed in the image rotation processing operation; however, when the content is not a type sensitive to an input lag, it may be operated according to the SOC rotation mode. When the SOC rotation mode is selected as the display rotation mode, the electronic device 100 may perform a display rotation control operation by rotating and displaying an image. The display rotation control operation according to the SOC rotation mode has been described above with reference to FIG. 7.

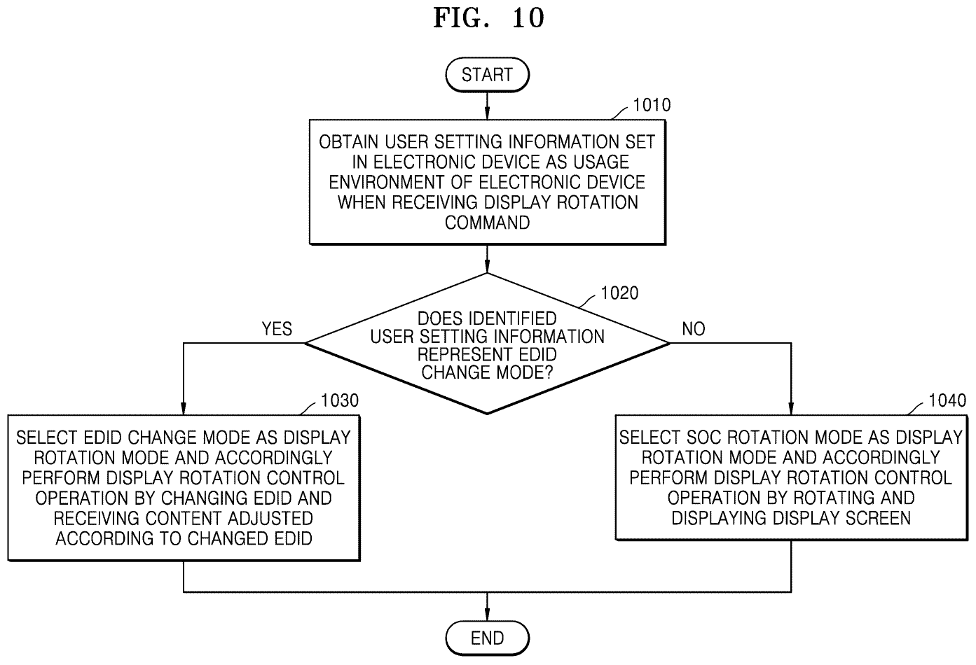

FIG. 10 illustrates an example of an operation method of an electronic device operating according to a display rotation command, according to an embodiment.

Referring to FIG. 10, in operation 1010, when receiving a display rotation command, the electronic device 100 may obtain the user setting information set in the electronic device as the usage environment of the electronic device 100.

In operation 1020, the electronic device 100 may determine whether the obtained user setting information represents the EDID change mode. The user setting information may represent one of the EDID change mode or the SOC rotation mode.

As a result of the determination in operation 1020, when the user setting information represents the EDID change mode, the operation method may proceed to operation 1030, and when the user setting information represents the SOC rotation mode, the operation method may proceed to operation 1040.

In operation 1030, the electronic device 100 may select the EDID change mode as the display rotation mode. When the EDID change mode is selected as the display rotation mode, the electronic device 100 may perform a display rotation control operation by changing the EDID and receiving content adjusted according to the changed EDID. The display rotation control operation according to the EDID change mode has been described above with reference to FIGS. 5 and 6.

In operation 1040, the electronic device 100 may select the SOC rotation mode as the display rotation mode. When the SOC rotation mode is selected as the display rotation mode, the electronic device 100 may perform a display rotation control operation by rotating and displaying an image. The display rotation control operation according to the SOC rotation mode has been described above with reference to FIG. 7.

When there is a display rotation command, the usage environment obtained by the electronic device 100 may include various information items, for example, the type of the source device connected to the electronic device 100, the type of the content displayed on the electronic device 100, the user setting information, and the like as described above.

According to an embodiment, the electronic device 100 may perform a display rotation control operation based on each of the information items obtained as the usage environment. As described above, the display rotation control operation may be performed based on the type of the source device connected to the electronic device 100 (FIG. 8), the display rotation control operation may be performed based on the type of the content displayed on the electronic device 100 (FIG. 9), or the display rotation control operation may be performed based on the user setting information (FIG. 10).

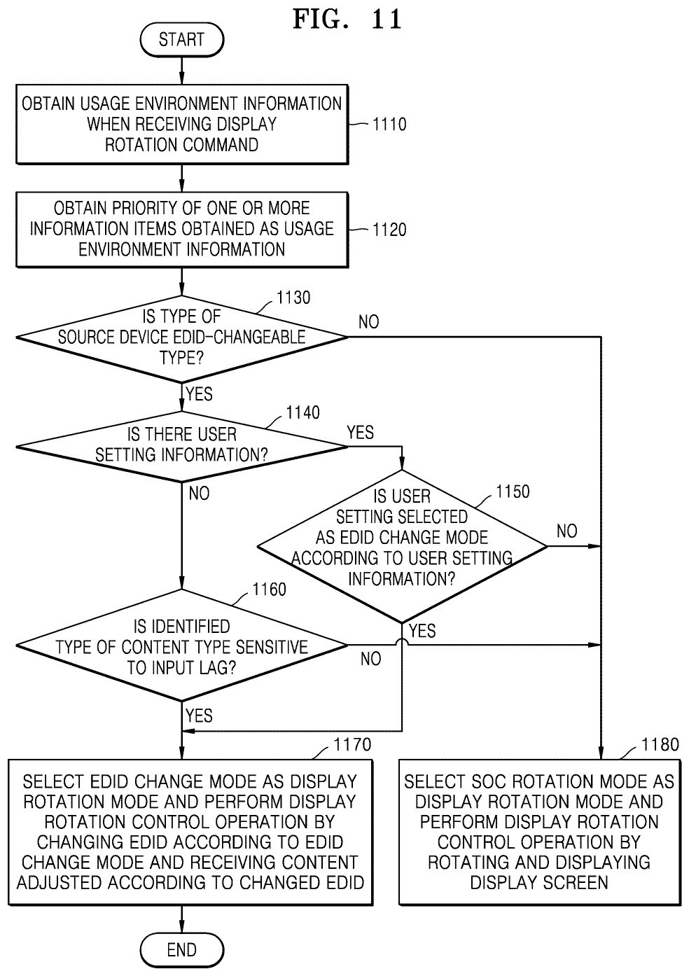

According to an embodiment, the electronic device 100 may perform a display rotation control operation based on one or more of the information items obtained as the usage environment. The electronic device 100 may prioritize one or more information items obtained as the usage environment and perform a display rotation control operation based on the priority. A method of performing the display rotation control operation based on the priority of one or more information items will be described with reference to FIG. 11.

FIG. 11 illustrates an example of a flowchart of a method by which an electronic device 100 performs a display rotation control operation based on one or more of information items obtained as a usage environment, according to an embodiment.

Referring to FIG. 11, in operation 1110, the electronic device 100 may identify the usage environment of the electronic device 100 when receiving a display rotation command. The electronic device 100 may obtain, as the usage environment information of the electronic device 100, information about the type of the source device connected to the electronic device 100, information about the type of the content displayed on the electronic device 100, user setting information, and the like.

In operation 1120, the electronic device 100 may obtain the priorities of one or more information items obtained as the usage environment information. The priorities of the one or more information items may be preregistered. For example, the priorities may be given such that the type of the source device has the highest priority, the user setting information has the second priority, and the type of the content has the last priority. However, this is merely an example, and the priorities may be determined in various ways depending on the policy of the electronic device 100.

In operation 1130, the electronic device 100 may determine whether the type of the source device is an EDID-changeable type according to the priority. As a result of the determination, when the type of the source device connected to the electronic device 100 is not an EDID-changeable type, the method may proceed to operation 1180. As a result of the determination, when the type of the source device connected to the electronic device 100 is an EDID-changeable type, the method may proceed to operation 1140.

In operation 1180, when the currently connected source device is not EDID-changeable, the electronic device 100 may perform a display rotation control operation by selecting the SOC rotation mode as the display rotation mode and rotating and displaying the display screen in the electronic device 100.

In operation 1140, the electronic device 100 may determine whether there is user setting information. When there is user setting information, the method may proceed to operation 1150, and when there is no user setting information, the method may proceed to operation 1160.

In operation 1150, the electronic device 100 may determine whether the user setting is selected as the EDID change mode according to the user setting information. As a result of the determination, when the user setting is selected as the EDID change mode, the method may proceed to operation 1170, and when the user setting is not selected as the EDID change mode, the method may proceed to operation 1180. In operation 1180, the electronic device 100 may select the SOC rotation mode as the display rotation mode and operate accordingly.

In operation 1160, the electronic device 100 may identify the type of the content and determine whether the type of the content is a type sensitive to an input lag. As a result of the determination, when the type of the content is not a type sensitive to an input lag, the method may proceed to operation 1180 to select the SOC rotation mode as the display rotation mode. As a result of the determination, when the type of the content is a type sensitive to an input lag, the method may proceed to operation 1170.

In operation 1170, the electronic device 100 may perform a display rotation control operation by selecting the EDID change mode as the display rotation mode, changing the EDID according to the EDID change mode, and receiving content adjusted according to the changed EDID from the source device.

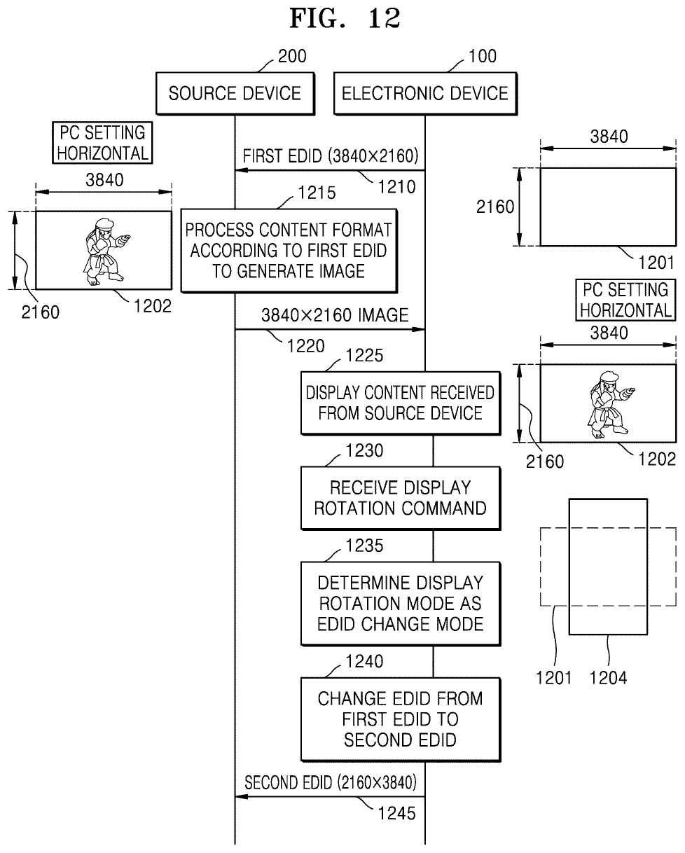

FIG. 12 is a flowchart of an example of a method of performing a display rotation control operation by changing EDID according to a display rotation command, according to an embodiment.

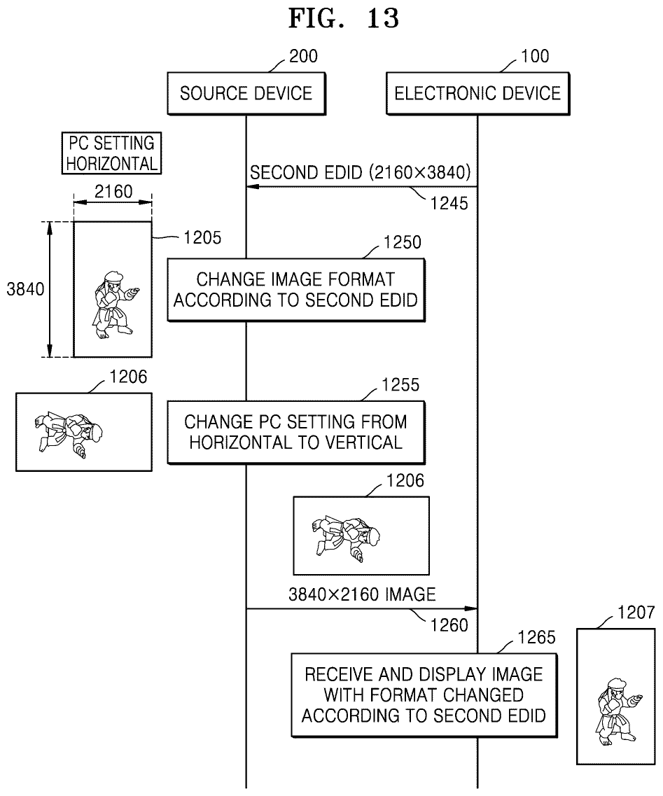

FIG. 13 is a flowchart of an example of a method of performing a display rotation control operation by changing EDID according to a display rotation command, according to an embodiment.

Referring to FIG. 12, in operation 1210, the electronic device 100 may transmit the first EDID including information (3840×2160) about the resolution of the display of the electronic device 100 to the source device 200 providing the content. In this case, the electronic device 100 may control the display to operate in a horizontal mode 1201.

In operation 1215, the source device 200 may generate a 3840×2160 image 1202 by processing the format of the content according to the first EDID received from the electronic device 100.

In operation 1220, the source device 200 may transmit the generated 3840×2160 image 1202 to the electronic device 100.

In operation 1225, the electronic device 100 may display the 3840×2160 image 1202 received from the source device on the display.

In operation 1230, the electronic device 100 may receive a display rotation command.

In operation 1235, the electronic device 100 may select the EDID change mode as the display rotation mode by considering the usage environment of the electronic device 100 according to the display rotation command. According to the display rotation command, the electronic device 100 may control the display to operate in a vertical mode 1204 by controlling the rotation of the display that has been operating in the horizontal mode 1201.

In operation 1240, the electronic device 100 may change the EDID from the first EDID to the second EDID. In order to display the image, which has been displayed in the horizontal mode, to fill the entire screen in the vertical mode, the resolution of the image may need to be adjusted. For this purpose, the electronic device 100 may change the EDID to match the resolution corresponding to the vertical mode.

In operation 1245, the electronic device 100 may transmit the second EDID (2160×3840) to the source device 200.

Referring to FIG. 13, in operation 1250, the source device 200 may generate an image 1205 with a resolution of 2160×3840 by changing the image format of the content according to the second EDID received from the electronic device 100.

In operation 1255, the source device 200 may change the PC setting from horizontal to vertical. That is, the image format may be changed in accordance with the resolution in the vertical mode according to the resolution change; however, because an image to be displayed on the rotated display may also need to be rotated according to the rotation of the display, the source device 200 may need to perform an operation of changing the PC setting from horizontal to vertical. As such, when the PC setting is changed from horizontal to vertical, the image 1205 may become an image 1206. Changing the PC setting from horizontal to vertical in the source device 200 may be performed by manually changing the setting according to a user input, or when there has been a previous agreement between the electronic device 100 and the source device 200, the electronic device 100 may transmit, to the source device 200, a command for changing the PC setting from horizontal to vertical or from vertical to horizontal, thereby causing the source device 200 to perform an operation corresponding to the command.

In operation 1260, the source device 200 may transmit the image 1206 to the electronic device 100.

According to an embodiment, when the source device 200 transmits the image 1206 to the electronic device 100, the image 1206 may be transmitted together with rotation information indicating that the image 1206 is a rotated image. The rotation information may include, for example, information indicating that the image 1206 has been rotated by 90 degrees from the original image. With reference to the rotation information, the electronic device 100 may identify that the image 1206 is a rotated image.

In operation 1265, the electronic device 100 may display the image 1206 received from the source device 200 on the display operating in the vertical mode.

According to an embodiment, when receiving the rotation information together with the image 1206, the electronic device 100 may identify, from the rotation information, that the image 1206 is a rotated image. In the case of the EDID change mode, the image rotated according to the display rotation may be displayed by not only receiving the image with the resolution changed based on the changed EDID but also receiving a rotated image for the image itself. When receiving the rotation information together with the image 1206, the electronic device 100 may identify that it has received a suitable image rotated according to the display rotation. When the electronic device 100 does not receive the rotation information together with the image 1206, the electronic device 100 may identify that it has not received a properly rotated image, and thus, in this case, it may take a suitable action to receive a rotated image. For example, when the electronic device 100 does not receive the rotation information together with the image 1206, the electronic device 100 may display a user notification for guiding the user to change the rotation setting of the source device 200, on the display through a pop-up window or the like. When there has been a previous agreement between the electronic device 100 and the source device 200, the electronic device 100 may transmit, to the source device 200, a command for instructing to change the rotation setting. Accordingly, the source device 200 that has received the command may change the rotation setting of the source device, that is, change the horizontal setting to the vertical setting, and transmit a rotated image to the electronic device 100 according to the rotation setting change.

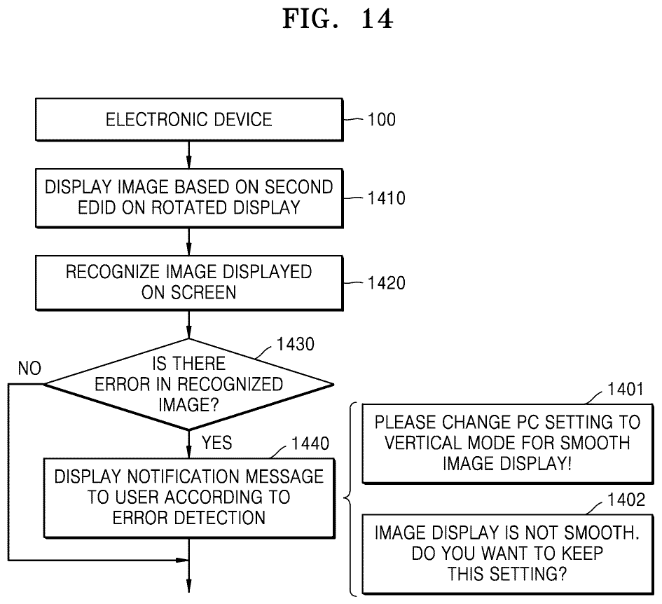

FIG. 14 illustrates an example of a method of performing a display rotation control operation by changing EDID according to a display rotation command, according to an embodiment.

Referring to FIG. 14, in operation 1410, the electronic device 100 may display an image based on the second EDID on a display rotated according to a display rotation command.

In operation 1420, the electronic device 100 may recognize an image displayed on the screen of the display.

In operation 1430, the electronic device 100 may determine whether there is an error in the recognized image and may end the method when there is no error as a result of the determination. Whether there is an error in the recognized image may be determined by identifying whether there is a black area on the screen or the like. Also, the electronic device 100 may determine whether the display screen is fully filled with the image based on the rotation information, the TV direction, and the resolution information, and when it is determined that the display screen is not fully filled with the image, the electronic device 100 may determine that there is an error in the image. As a result of the determination, when there is an error, the method may proceed to operation 1440.

In operation 1440, when it is determined that there is an error in the recognized image, the electronic device 100 may display a notification message to the user. In changing the EDID according to a display rotation command and displaying a received image on a rotated display according to the EDID change, when the electronic device 100 determines that there is an error in the displayed image, the electronic device 100 may provide a notification message to the user as a method of correcting the error. For example, the electronic device 100 may display a notification message 1401 such as <Please change PC setting to vertical mode for smooth image display!> to guide the user to set the vertical mode of the source device. Alternatively, the electronic device 100 may display a notification message 1402 such as <Image display is not smooth. Do you want to keep this setting? Yes No>. When the user selects <Yes> in response to the notification message 1402, the electronic device 100 may display the image while maintaining the current state thereof. When the user selects <No>, the electronic device 100 may change the currently set EDID change mode to the SOC rotation mode and perform a display rotation control operation according to the SOC rotation mode.

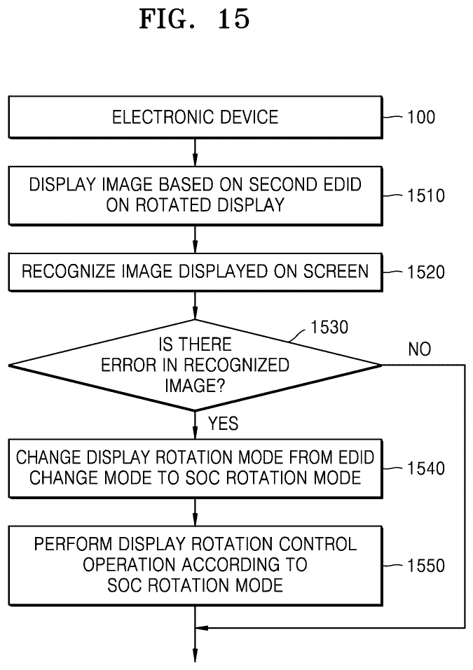

FIG. 15 illustrates an example of a method of performing a display rotation control operation by changing EDID according to a display rotation command, according to an embodiment.

Referring to FIG. 15, in operation 1510, the electronic device 100 may display an image based on the second EDID on a display rotated according to a display rotation command.

In operation 1520, the electronic device 100 may recognize an image displayed on the screen of the display.

In operation 1530, the electronic device 100 may determine whether there is an error in the recognized image and may end the method when there is no error as a result of the determination. As a result of the determination, when there is an error, the method may proceed to operation 1540.

In operation 1540, the electronic device 100 may change the currently set EDID change mode to the SOC rotation mode.

In operation 1550, the electronic device 100 may perform a display rotation control operation according to the SOC rotation mode.

Some embodiments may also be implemented in the form of computer-readable recording mediums including instructions executable by computers, such as program modules executed by computers. The computer-readable recording mediums may be any available mediums accessible by computers and may include both volatile and non-volatile mediums and detachable and non-detachable mediums. Also, the computer-readable recording mediums may include computer storage mediums. The computer storage mediums may include both volatile and non-volatile and detachable and non-detachable mediums implemented by any method or technology for storage of information such as computer-readable instructions, data structures, program modules, or other data.

The described embodiments may be implemented as S/W programs including instructions stored in computer-readable storage mediums.

The computer may be a device capable of calling instructions stored in a storage medium and performing an operation according to the described embodiment according to the called instructions and may include the electronic device according to the described embodiments.

The computer-readable storage medium may be provided in the form of a non-transitory storage medium. Here, “non-transitory” may merely mean that the storage medium does not include signals and is tangible, but does not distinguish semi-permanent or temporary storage of data in the storage medium.

Also, the control method according to the described embodiments may be included and provided in a computer program product. The computer program product may be traded as a product between a seller and a buyer.

The computer program product may include a S/W program and a computer-readable storage medium with a S/W program stored therein. For example, the computer program product may include products in the form of S/W programs (e.g., downloadable apps) electronically distributed through manufacturers of devices or electronic markets (e.g., Google Play Store and App Store). For electronic distribution, at least a portion of the S/W program may be stored in a storage medium or may be temporarily generated. In this case, the storage medium may be a storage medium of a server of a manufacturer, a server of an electronic market, or a relay server for temporarily storing the S/W program.

In a system including a server and a device, the computer program product may include a storage medium of the server or a storage medium of the device. Alternatively, when there is a third device (e.g., a smartphone) communicatively connected to the server or the device, the computer program product may include a storage medium of the third device. Alternatively, the computer program product may include the S/W program itself that is transmitted from the server to the device or the third device or transmitted from the third device to the device.

In this case, one of the server, the device, and the third device may execute the computer program product to perform the method according to the described embodiments. Alternatively, two or more of the server, the device, and the third device may execute the computer program product to perform the method according to the described embodiments in a distributed manner.

For example, the server (e.g., a cloud server or an artificial intelligence server) may execute the computer program product stored in the server, to control the device communicatively connected to the server to perform the method according to the described embodiment.

As another example, the third device may execute the computer program product to control the device communicatively connected to the third device to perform the method according to the described embodiments. When the third device executes the computer program product, the third device may download the computer program product from the server and execute the downloaded computer program product. Alternatively, the third device may perform the method according to the described embodiments by executing the computer program product provided in a preloaded state.

Also, herein, the “unit” may include a hardware component such as a processor or a circuit and/or a software component executed by a hardware component such as a processor.

The foregoing descriptions of the present disclosure are merely examples, and those of ordinary skill in the art will readily understand that various modifications may be made therein without materially departing from the spirit or features of the present disclosure. Therefore, it is to be understood that the embodiments described above should be considered in a descriptive sense only and not for purposes of limitation. For example, each component described as a single type may also be implemented in a distributed manner, and likewise, components described as being distributed may also be implemented in a combined form.

The scope of the present disclosure is defined not by the above detailed description but by the following claims, and all modifications derived from the meaning and scope of the claims and equivalent concepts thereof should be construed as being included in the scope of the present disclosure.

1. An electronic device comprising:
memory to store one or more instructions; and
at least one processor, individually and/or collectively, configured to execute the one or more instructions stored in the memory to cause the electronic device to:
identify a usage environment of the electronic device based on receiving a request associated with displaying an image through a display of the electronic device,
select one of a first mode or a second mode based on which the image is to be displayed, according to the identified usage environment of the electronic device,
based on the first mode being selected, change Extended Display Identification Data (EDID), transmit the changed EDID to a source device from which the image is received, receive an adjusted image according to the changed EDID from the source device, and display the adjusted image on the display, and
based on the second mode being selected, rotate the image received from the source device and display the rotated image on the display.

2. The electronic device of claim 1, wherein the at least one processor, individually and/or collectively, is configured to execute the one or more instructions stored in the memory to cause the electronic device to:
obtain at least one of information about a type of the source device, which is connected to the electronic device, user setting information according to a user input, or information about a type of content displayed on the electronic device to identify the usage environment of the electronic device.

3. The electronic device of claim 2, wherein the information about the type of the source device, the user setting information, and the information about the type of the content are set with defined priorities, and
the at least one processor, individually and/or collectively, is configured to execute the one or more instructions stored in the memory to cause the electronic device to:
select one of the first mode or the second mode by considering the usage environment of the electronic device from the information with a highest priority.

4. The electronic device of claim 1, wherein the usage environment of the electronic device includes a type of the source device connected to the electronic device, and
the at least one processor, individually and/or collectively, is configured to execute the one or more instructions stored in the memory to cause the electronic device to:
identify the type of the source device connected to the electronic device based on receiving the request, and
select the first mode based on the identified type of the source device is identified as an EDID-changeable device and select the second mode based on the identified type of the source device is identified as an EDID-unchangeable device.

5. The electronic device of claim 1, wherein the usage environment of the electronic device includes a type of content displayed on the electronic device, and
the at least one processor, individually and/or collectively, is configured to execute the one or more instructions stored in the memory to cause the electronic device to:
identify the type of the content displayed on the electronic device based on receiving the request, and
select the first mode based on the identified type of the content is identified as content sensitive to an input lag and select the second mode based on the identified type of the content is identified as content not sensitive to an input lag.

6. The electronic device of claim 1, wherein the usage environment of the electronic device includes user setting information according to a user input, and
the at least one processor, individually and/or collectively, is configured to execute the one or more instructions stored in the memory to cause the electronic device to:
identify the user setting information based on receiving the request, and
select one of the first mode or the second mode according to the identified user setting information.

7. The electronic device of claim 1, wherein the at least one processor, individually and/or collectively, is configured to execute the one or more instructions stored in the memory to cause the electronic device to, based on selecting the first mode,
change EDID of the electronic device from first EDID to second EDID,
provide the second EDID to the source device and receive an image adjusted according to the second EDID from the source device, and
control the adjusted image to be displayed on the display rotated according to the request.

8. The electronic device of claim 7, wherein the at least one processor, individually and/or collectively, is configured to execute the one or more instructions stored in the memory to cause the electronic device to:
detect that an error has occurred in a screen display of the adjusted image displayed on the rotated display,
change from the first mode to the second mode according to detection of the error, and
perform a display rotation control operation according to the second mode.

9. The electronic device of claim 7, wherein the at least one processor, individually and/or collectively, is configured to execute the one or more instructions stored in the memory to cause the electronic device to:
detect that an error has occurred in a screen display of the adjusted image displayed on the rotated display, and
perform control to display a notification message to a user according to detection of the error.

10. An operation method of an electronic device, the operation method comprising:
identifying a usage environment of the electronic device based on receiving a request associated with displaying an image through a display of the electronic device;
selecting one of a first mode or a second mode based on which the image is to be displayed, according to the identified usage environment of the electronic device;
based on the first mode being selected, changing Extended Display Identification Data (EDID), transmitting the changed EDID to a source device from which the image is received, receiving an image adjusted according to the changed EDID from the source device, and displaying the adjusted image on a display; and
based on the second mode being selected, rotating the image received from the source device and displaying the rotated image on the display.

11. The operation method of claim 10, further comprising obtaining at least one of information about a type of the source device connected to the electronic device, user setting information according to a user input, or information about a type of content displayed on the electronic device so as to identify the usage environment of the electronic device.

12. The operation method of claim 11, wherein the information about the type of the source device, the user setting information, and the information about the type of the content are set with defined priorities, and
the operation method further comprises selecting one of the first mode or the second mode by considering the usage environment of the electronic device from the information with a highest priority.

13. The operation method of claim 10, further comprising:
identifying information about a type of the source device connected to the electronic device as the usage environment of the electronic device; and
selecting the first mode based on the identified type of the source device is identified as an EDID-changeable device and selecting the second mode based on the identified type of the source device is identified as an EDID-unchangeable device.

14. The operation method of claim 10, further comprising:
identifying a type of content displayed on the electronic device as the usage environment of the electronic device; and
selecting the first mode based on the identified type of the content is identified as content sensitive to an input lag and selecting the second mode based on the identified type of the content is identified as content not sensitive to an input lag.

15. A non-transitory computer-readable recording medium having recorded therein one or more program executed by a processor of an electronic device for implementation of an operation method of the electronic device, the operation method comprising:
identifying a usage environment of the electronic device based on receiving a request associated with displaying an image through a display of the electronic device;
selecting one of a first mode or a second mode based on which the image is to be displayed, according to the identified usage environment of the electronic device;
based on the first mode being selected, changing Extended Display Identification Data (EDID), transmitting the changed EDID to a source device from which the image is received, receiving an adjusted image according to the changed EDID from the source device, and displaying the adjusted image on the display; and
based on the second mode being selected, rotating the image received from the source device and displaying the rotated image on the display.
